(19) United States
(12) Patent Application Publication
(10) Pub. No.: US 2026/0017981 A1
(43) Pub. Date: Jan. 15, 2026

(54) EYE TRACKING APPARATUS AND SMART GLASSES

(71) Applicant: VIVO MOBILE COMMUNICATION CO., LTD., Dongguan (CN)

(72) Inventors: Huaxin LIN, Dongguan (CN); Ling XIONG, Dongguan (CN)

(73) Assignee: VIVO MOBILE COMMUNICATION CO., LTD., Dongguan (CN)

(21) Appl. No.: 19/337,846

(22) Filed: Sep. 23, 2025

Related U.S. Application Data
(63) Continuation of application No. PCT/CN2024/082693, filed on Mar. 20, 2024.

(30) Foreign Application Priority Data
Mar. 24, 2023 (CN) 202310305649.3

(51) Int. Cl. G06V 40/19; G02B 27/01

(52) U.S. Cl. CPC G06V 40/19; G02B 27/017; G02B 2027/0178

(57) ABSTRACT

An eye tracking apparatus and smart glasses are provided. The eye tracking apparatus includes a fill light source, configured to emit to human eyes a first fill light ray with a first predetermined central wavelength or a second fill light ray with a second predetermined central wavelength based on ambient light intensity of the human eyes, solar spectral irradiance corresponding to the first and the second predetermined central wavelengths is less than a predetermined threshold, and a band range of the first fill light ray is different from a band range of the second fill light ray; a camera, configured to acquire a pupil image formed when the first or the second fill light ray irradiates the human eyes; and a processor, configured to determine movement of the human eyes based on the pupil image.

### CROSS-REFERENCES TO RELATED APPLICATIONS

This application is a continuation of International Application No. PCT/CN2024/082693, filed Mar. 20, 2024, which claims priority to Chinese Patent Application No. 202310305649.3, filed Mar. 24, 2023. The entire contents of each of the above-referenced applications are expressly incorporated herein by reference.

### TECHNICAL FIELD

This application pertains to the field of communication technologies, and particularly relates to an eye tracking apparatus and smart glasses.

### BACKGROUND

Eye tracking technology is deployed on smart glasses including those for virtual reality (VR), augmented reality (AR), and mixed reality (MR). It is used to track eye movement by measuring either the gaze point of a smart classes user or the motion of an eye relative to the head, with the purpose of monitoring the eye movement and gaze direction of the user watching a specific target.

Usually, an eye tracking apparatus adopts a corneal reflection method, in which an infrared light source irradiates a user's eyes, generating a blinking point on the cornea. The blinking point is generated by reflecting light rays entering the pupil on the outer surface of the cornea. A pupil image accompanying the reflection is captured by a camera sensitive to infrared spectrum. The center of the pupil is calculated by means of image processing technology, and then movement of the pupil relative to the corneal reflection is measured, so that the user's gaze point can be estimated.

The involved eye tracking apparatuses are all near-infrared (NIR) optical systems, and the selected fill light lamp is a light-emitting diode (LED), where the central wavelength of the fill light lamp is usually 850 nm or 940 nm. However, when smart glasses are used outdoors, strong sunlight interference significantly degrades the image quality. To improve the image quality, the power of the fill light lamp needs to be increased. However, power increase of the fill light lamp leads to an increase both in power consumption and harm to human eyes, resulting in visual fatigue and even cataracts and retinal burns.

### SUMMARY

Embodiments of this application are intended to provide an eye tracking apparatus and smart glasses.

According to a first aspect, an embodiment of this application provides an eye tracking apparatus. The eye tracking apparatus includes a fill light source configured to emit to human eyes a first fill light ray with a first predetermined central wavelength or a second fill light ray with a second predetermined central wavelength based on ambient light intensity of the human eyes, where solar spectral irradiance corresponding to the first predetermined central wavelength and the second predetermined central wavelength is less than a predetermined threshold, and a band range of the first fill light ray is different from a band range of the second fill light ray. The eye tracking apparatus further includes a camera configured to acquire a pupil image formed when the first fill light ray or the second fill light ray irradiates the human eyes. The eye tracking apparatus further includes a processor configured to determine movement of the human eyes based on the pupil image, where the camera tracks the movement of the human eyes.

According to a second aspect, an embodiment of this application provides an eye tracking method, applied to the eye tracking apparatus according to the first aspect. The method includes emitting to human eyes a first fill light ray with a first predetermined central wavelength or a second fill light ray with a second predetermined central wavelength based on ambient light intensity of the human eyes, where solar spectral irradiance corresponding to the first predetermined central wavelength and the second predetermined central wavelength is less than a predetermined threshold, and a band range of the first fill light ray is different from a band range of the second fill light ray. The method further includes acquiring a pupil image formed when the first fill light ray or the second fill light ray irradiates the human eyes; and determining movement of the human eyes based on the pupil image.

According to a third aspect, an embodiment of this application provides smart glasses, including a light intensity sensor, and the eye tracking apparatus according to the first aspect, where the eye tracking apparatus is arranged at positions on the smart glasses corresponding to human eyes; the light intensity sensor is connected to the processor, and the light intensity sensor is configured to detect and transmit ambient light intensity of the human eyes to the processor; and the processor is configured to drive the fill light source to emit the first fill light ray or the second fill light ray to the human eyes, based on a result of comparison between the ambient light intensity and the predetermined light intensity threshold.

In the embodiments of this application, the fill light source included in the eye tracking apparatus is configured to emit to human eyes a fill light ray with a first predetermined central wavelength or a fill light ray with a second predetermined central wavelength based on ambient light intensity of the human eyes, solar spectral irradiance corresponding to the first predetermined central wavelength and the second predetermined central wavelength is less than a predetermined threshold, and a band range of the fill light ray with the first predetermined central wavelength is different from a band range of the fill light ray with the second predetermined central wavelength. In addition, a camera is configured to acquire a pupil image formed when the fill light ray irradiates the human eyes and transmit it to a processor, and the processor determines movement of the human eyes based on the pupil image, where the camera tracks the movement of the human eyes. Fill light rays whose central wavelength corresponds to a solar spectral irradiance below a predetermined threshold are emitted. This can minimize or even eliminate the interference of sunlight on the fill light rays emitted by the fill light source to human eyes even under strong outdoor light. As a result, a pupil image with a high signal-to-noise ratio can be obtained through that fill light ray, thereby improving the pupil image quality. In addition, this further avoids the increase of power consumption and harm to human eyes caused by increasing the power of the fill light lamp for improved pupil image quality. Furthermore, human eyes are irradiated by fill light rays of various wavelengths based on ambient light intensity of human eyes, and different fill light sources are used according to different ambient light intensities. This reduces the power consumption of the eye tracking apparatus and improves the operational efficiency thereof.

### BRIEF DESCRIPTION OF DRAWINGS

FIG. 1 is a structural block diagram of an eye tracking apparatus according to an embodiment of this application.

FIG. 2 is a schematic diagram of components of the solar spectrum.

FIG. 3 is a first schematic structural diagram of an eye tracking apparatus according to an embodiment of this application.

FIG. 4 is a second schematic structural diagram of an eye tracking apparatus according to an embodiment of this application.

FIG. 5 is a third schematic structural diagram of an eye tracking apparatus according to an embodiment of this application.

FIG. 6 is a schematic flowchart of an eye tracking method according to an embodiment of this application.

FIG. 7 is a schematic structural diagram of smart glasses according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that data used in this way is used interchangeably in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

The following describes in detail the eye tracking apparatus and smart glasses provided in the embodiments of this application through specific embodiments and application scenarios thereof with reference to the accompanying drawings.

In an embodiment, an eye tracking apparatus is provided. The eye tracking apparatus includes a fill light source, where the fill light source is configured to emit to human eyes a first fill light ray with a first predetermined central wavelength or a second fill light ray with a second predetermined central wavelength based on ambient light intensity of the human eyes, solar spectral irradiance corresponding to the first predetermined central wavelength and the second predetermined central wavelength is less than a predetermined threshold, and a band range of the first fill light ray is different from a band range of the second fill light ray; a camera, configured to acquire a pupil image formed when the first fill light ray or the second fill light ray irradiates the human eyes; and a processor, configured to determine movement of the human eyes based on the pupil image, where the camera tracks the movement of the human eyes.

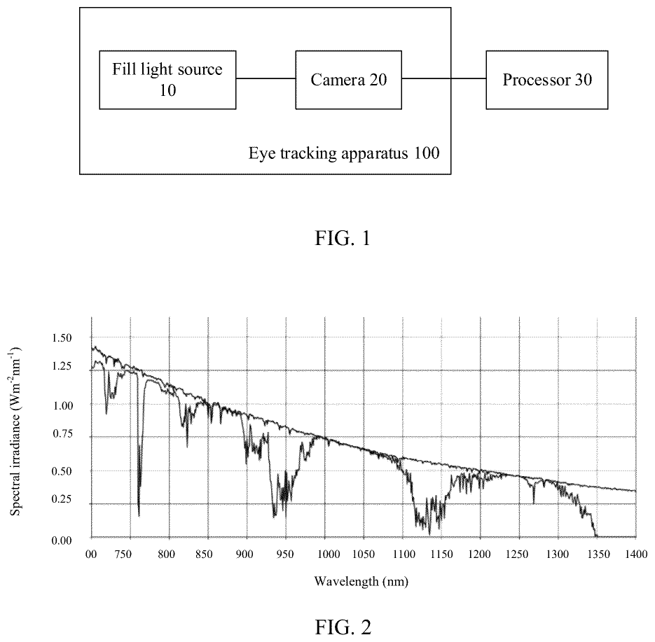

FIG. 1 is a schematic structural diagram of an eye tracking apparatus according to an embodiment of this application. An eye tracking apparatus 100 according to the embodiment of this application can be arranged on smart glasses for acquiring pupil images of users wearing the smart glasses.

As shown in FIG. 1, the eye tracking apparatus 100 includes a fill light source 10 and a camera 20. The fill light source 10 is configured to emit a light ray to the human eyes of a user wearing smart glasses, and the light ray emitted by the fill light source 10 directly enters the human eyes without passing through any other media except air. The light ray entering the pupil is reflected on the outer surface of the cornea of the human eyes to generate blinking points.

In this embodiment of this application, the fill light source 10 can emit either of two fill light rays with different central wavelengths to human eyes based on the ambient light intensity of the human eyes, that is, a first fill light ray with a first predetermined central wavelength or a second fill light ray with a second predetermined central wavelength. For indoor environments, the ambient light intensity of human eyes may be determined by the intensity of both lighting and/or sunlight entering the room. For outdoor daytime environments, the ambient light intensity of human eyes is usually determined by the intensity of sunlight.

Moreover, the solar spectral irradiance corresponding to the first predetermined central wavelength and the second predetermined central wavelength is less than a predetermined threshold, and the predetermined threshold used herein may be close to zero. These two light rays have different band ranges. In other words, the band ranges do not overlap. A band range is determined based on the central wavelength and wavelength bandwidth. For example, if the central wavelength is a, and the wavelength bandwidth is b, the band range is a±b.

The fill light source emits fill light rays with a central wavelength corresponding to the solar spectral irradiance being close to zero. Even when the smart glasses are used under strong outdoor light, the interference of the ambient sunlight on the fill light rays can be minimized or eliminated. In this case, the signal-to-noise ratio of the pupil image formed by human eye reflection is high, and the image quality will not be degraded.

Whether the fill light source 10 emits the fill light ray with the first predetermined central wavelength or the second predetermined central wavelength based on the ambient light intensity of human eyes will be described below. However, no matter which fill light ray is emitted, the solar spectral irradiance corresponding to the central wavelength of the fill light ray needs to be less than the foregoing predetermined threshold.

In some embodiments, the first predetermined central wavelength is between 1119 nm and 1121 nm, and the second predetermined central wavelength is between 1370 nm and 1390 nm. In some embodiments, the first predetermined central wavelength is between 1370 nm and 1390 nm, and the second predetermined central wavelength is between 1370 nm and 1390 nm. The band range of the fill light ray with the first predetermined central wavelength is determined based on the first predetermined central wavelength and a predetermined wavelength bandwidth, and the band range of the fill light ray with the second predetermined central wavelength is determined based on the second predetermined central wavelength and the predetermined wavelength bandwidth, where the predetermined wavelength bandwidth is between 20 nm and 50 nm.

With reference to FIG. 2, which is the schematic diagram of components of the solar spectral, for example, the solar spectral irradiance is close to zero at wavelengths around 1120 nm and 1380 nm, and the near-infrared light is invisible. Moreover, photons with wavelengths around 1120 nm and 1380 nm possess low energy, posing a reduced risk of harm to human eyes. This is especially true for 1380 nm as its photon energy is significantly attenuated before reaching the retina.

Therefore, the fill light source emits the fill light ray with the central wavelength of 1119 nm to 1121 nm or the fill light ray with the central wavelength of 1370 nm to 1390 nm. When the solar spectral irradiance of the fill light ray is close to zero, the ambient sunlight hardly interferes with the fill light ray, and the fill light ray does not degrade the quality of pupil images reflected by outdoor human eyes. In addition, the fill light ray at such wavelengths has low photon energy, reducing harm to human eyes.

Being around 1120 nm and 1380 nm means that the wavelength bandwidth is greater than 20 nm and less than 50 nm. For example, in a case of around 1380 nm, 1380 nm±20 nm is selected, and the wavelength bandwidth is 40 nm; in a case of around 1120 nm, 1120 nm±10 nm is selected, and the wavelength bandwidth is 20 nm.

The camera 20 tracks the movement of human eyes, and is configured to acquire the pupil image formed by reflection when the fill light ray irradiates the human eyes, and transmit it to a processor 30. The processor 30 determines the movement of the human eyes based on the pupil image.

As mentioned above, the fill light source 10 can emit to the human eyes the fill light ray with the first predetermined central wavelength or the second predetermined central wavelength. Specifically, a dual-wavelength fill light lamp system is adopted, and two light sources emit fill light rays with corresponding central wavelengths.

In some embodiments, the fill light source includes a first fill light source and a second fill light source, where the first fill light source is configured to emit the first fill light ray to the human eyes in a case that the ambient light intensity is not greater than a predetermined light intensity threshold; and the second fill light source is configured to emit the second fill light ray to the human eyes in a case that the ambient light intensity is greater than the predetermined light intensity threshold, where the band range of the second fill light ray is greater than the band range of the first fill light ray.

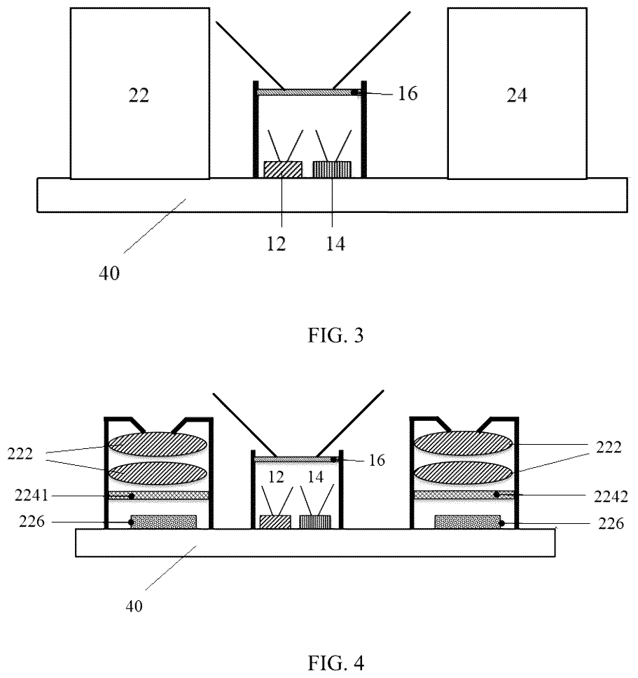

FIG. 3 is a schematic structural diagram of an eye tracking apparatus according to an embodiment of this application. As shown in FIG. 3, the fill light source 10 includes a first fill light source 12 and a second fill light source 14, where the first fill light source 12 and the second fill light source 14 may be two light source chips.

In some embodiments, the fill light source includes a vertical-cavity surface-emitting laser light source.

For example, both light source chips use a vertical-cavity surface-emitting laser (VCSEL) light source.

In this embodiment, a band range of the second fill light ray emitted by the second fill light source 14 is greater than a band range of the first fill light ray emitted by the first fill light source 12.

A larger band range means lower luminous efficiency, and the electro-optical conversion efficiency of the first fill light source 12 is higher than that of the second fill light source 14.

For example, the first predetermined central wavelength is between 1119 nm and 1121 nm, and the second predetermined central wavelength is between 1370 nm and 1390 nm. Correspondingly, the first fill light source 12 has higher electro-optical conversion efficiency than the second fill light source 14. Therefore, the first fill light source 12 features low power consumption when there is no sunlight interference in indoor environments. Compared with the first fill light source 12, the second fill light source 14 has smaller solar spectral irradiance under strong outdoor light, featuring no sunlight interference, high signal purity, and low photon energy. Therefore, the second fill light source 14 has the advantages of lower power consumption and less harm to human eyes.

The predetermined light intensity threshold is a threshold used for distinguishing between indoor environments and outdoor environments. This threshold can be detected by a light intensity sensor arranged on the smart glasses. The detection result is transmitted to the processor 30, and the processor 30 controls to switch on the corresponding fill light source, so as to emit the fill light ray with the required central wavelength.

Therefore, the first fill light source is switched on in a case that the ambient light intensity is not greater than the predetermined light intensity threshold, that is, in indoor environments, so as to emit to the human eyes the first fill light ray with the first predetermined central wavelength. When the ambient light intensity is greater than the predetermined light intensity threshold, that is, in outdoor environments, the second fill light source is switched on to emit to the human eyes the second fill light ray with the second predetermined central wavelength.

As shown in FIG. 3, a diffuser 16 is provided above the two fill light sources, and the diffuser 16 modulates the Gaussian light field emitted by the VCSEL fill light source into a uniformly distributed light field, so as to provide uniform lighting while increasing the exit angle. For example, the exit angle is 40° to 60° in both horizontal and vertical directions, entire human eyes are irradiated uniformly. The fill light ray emitted to human eyes is reflected to form a pupil image, which is acquired by the camera.

In a case of different central wavelengths for the fill light source, a camera with different filtering effects is needed. In some embodiments, the camera includes a first camera and a second camera, where the first camera is configured to acquire the pupil image formed when the first fill light ray irradiates the human eyes, and the second camera is configured to acquire the pupil image formed when the second fill light ray irradiates the human eyes.

As shown in FIG. 3, the eye tracking apparatus includes the first fill light source 12 and the second fill light source 14, and correspondingly includes a first camera 22 and a second camera 24. The first camera 22 is configured to acquire the pupil image formed when the first fill light source 12 irradiates human eyes, and the second camera 24 is configured to acquire the pupil image formed when the second fill light source 14 irradiates human eyes.

The first fill light source 12, the second fill light source 14, the first camera 22, and the second camera 24 are arranged on a printed circuit board 40.

In some embodiments, the camera includes a receiver device and an image sensor that are stacked, where the receiver device is configured to receive a fourth light ray, where the fourth light ray is a light ray with the same band as the emitted fill light ray among a third light ray reflected by the human eyes when the first fill light ray or the second fill light ray irradiates the human eyes; and the image sensor is configured to convert an optical signal of the fourth light ray into an electrical signal.

The receiver device includes a lens and an optical filter layer. The fill light ray is emitted to human eyes for reflection to form a pupil image, and the pupil image is transmitted together with ambient light rays in the form of light rays. The receiver device uses the lens and the optical filter layer to filter and acquire the light rays at the fill light ray band among the received light rays in various bands, so as to acquire an imaging optical signal corresponding to the pupil image. The image sensor of the camera receives the optical signal, converts it into an electrical signal, and transmits it to the processor 30 for image processing and eye tracking.

In some embodiments, the image sensor includes a colloidal quantum dot sensor.

The image sensor of the camera adopts the colloidal quantum dot (CQD) sensor, which can respond at around 1120 nm and 1380 nm. The photosensitive material of CQD sensor is colloidal quantum dot.

In an embodiment, In some embodiments, the receiver device includes a receiving lens and an optical filter that are stacked, where the receiving lens is a plastic aspheric structure and is configured to converge the third light ray; and the optical filter is configured to allow the fourth light ray in the converged third light ray to pass through.

As shown in FIG. 4, the receiver device of the first camera 22 includes a receiving lens 222 and an optical filter 2241. The receiving lens 222 may be designed with two plastic aspheric surfaces for converging the third light ray reflected by human eyes. The optical filter 2241 is arranged below the receiving lens 222, and is configured to allow the fourth light ray in the converged third light ray to pass through. In some embodiments, the light ray, in the third light ray, with the same band as the first fill light ray is allowed to pass through and enter the image sensor 226 below.

Similarly, as shown in FIG. 4, the receiver device of the second camera 24 includes a receiving lens 222 and an optical filter 2242. The receiving lens 222 is also designed with two plastic aspheric surfaces for converging the light ray reflected by human eyes. The optical filter 2242 is arranged below the receiving lens 222, and is configured to allow the fourth light ray in the converged third light ray to pass through. In some embodiments, the light ray, in the third light ray, with the same band as the second fill light ray is allowed to pass through and enter the image sensor 226 below.

For example, the first camera 22 acquires light with a wavelength of 1120 nm emitted by the first fill light source 12. In this case, the optical filter 2241 only allows light with a wavelength around 1120 nm to pass through. The optical filter 2241 is, for example, a narrow-band filter. The passband of a narrow-band filter is relatively narrow, generally less than 5% of the central wavelength.

For example, the second camera 24 acquires light with a wavelength of 1380 nm emitted by the second fill light source 14. In this case, the optical filter 2242 only allows light with a wavelength around 1380 nm to pass through. The optical filter 2242 is, for example, a narrow-band filter.

The filtered light is processed by the image sensor 226 arranged below the optical filter, which is not described herein.

In another embodiment, In some embodiments, the receiver device is a superlens, and the superlens includes a glass substrate, optical filter layers stacked on a first surface of the glass substrate close to the human eyes, and microstructures stacked on a second surface of the glass substrate away from the human eyes; where the optical filter layer is configured to allow the fourth light ray in the third light ray to pass through; and the microstructure is configured to converge the fourth light ray.

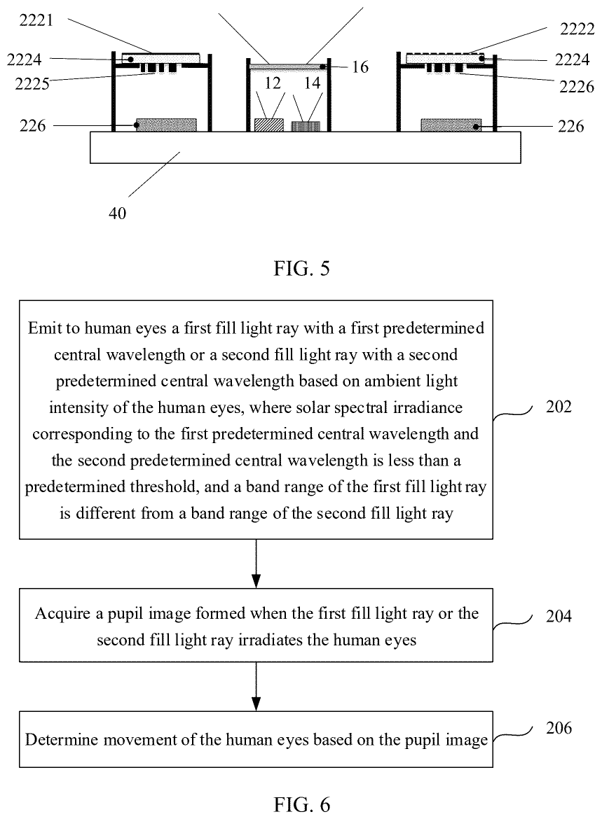

As shown in FIG. 5, the receiver device of the first camera 22 is a superlens, and the superlens includes a glass substrate 2224, optical filter layers 2221 stacked on an upper surface of the glass substrate 2224 close to human eyes, and microstructures 2225 stacked on a lower surface of the glass substrate 2224 away from human eyes.

The optical filter layer 2221 on the upper surface is configured to allow the fourth light ray in the third light ray to pass through. In some embodiments, the light ray, in the third light ray, with the same wavelength band as the first fill light ray is allowed to pass through and enter the microstructure 2225 below. The microstructure 2225 is configured to converge the light rays reflected by human eyes and emit the converged light ray to the image sensor 226 below.

Similarly, as shown in FIG. 5, the receiver device of the second camera 24 is a superlens, and the superlens includes a glass substrate 2224, optical filter layers 2222 stacked on an upper surface of the glass substrate 2224 close to human eyes, and microstructures 2226 stacked on a lower surface of the glass substrate 2224 away from human eyes.

The optical filter layer 2222 on the upper surface is configured to allow the fourth light ray in the third light ray to pass through. In some embodiments, the light ray, in the third light ray, with the same wavelength band as the second fill light ray is allowed to pass through and enter the microstructure 2226 below. The microstructure 2226 is configured to converge the light rays reflected by human eyes and emit the converged light ray to the image sensor 226 below.

For example, the first camera 22 acquires light with a wavelength of 1120 nm emitted by the first fill light source 12. In this case, the optical filter layer 2221 only allows light with a wavelength around 1120 nm to pass through. The optical filter 2221 is, for example, a narrow-band filter layer.

For example, the second camera 24 acquires light with a wavelength of 1380 nm emitted by the second fill light source 14. In this case, the optical filter layer 2222 only allows light with a wavelength around 1380 nm to pass through. The optical filter 2242 is, for example, a narrow-band filter layer.

In the foregoing embodiment, the receiver devices of the first camera 22 and the second camera 24 may adopt the same or different structures.

In this embodiment of this application, the fill light source included in the eye tracking apparatus is configured to emit to human eyes a first fill light ray with a first predetermined central wavelength or a second fill light ray with a second predetermined central wavelength based on ambient light intensity of the human eyes, solar spectral irradiance corresponding to the first predetermined central wavelength and the second predetermined central wavelength is less than a predetermined threshold, and a band range of the first fill light ray is different from a band range of the second fill light ray. In addition, a camera tracks movement of human eyes and acquire a pupil image formed when the fill light ray irradiates the human eyes, and transmits the pupil image to a processor, so that the processor determines the movement of human eyes based on the pupil image. Fill light rays whose central wavelength corresponds to a solar spectral irradiance below a predetermined threshold are emitted. This can minimize or even eliminate the interference of sunlight on the fill light rays emitted by the fill light source to human eyes even under strong outdoor light. As a result, a pupil image with a high signal-to-noise ratio can be obtained through that fill light ray, thereby improving the pupil image quality. In addition, this further avoids the increase of power consumption and harm to human eyes caused by increasing the power of the fill light lamp for improved pupil image quality. Furthermore, human eyes are irradiated by fill light rays of various wavelengths based on ambient light intensity of human eyes, and different fill light sources are used according to different ambient light intensities. This reduces the power consumption of the eye tracking apparatus and improves the operational efficiency thereof.

In some embodiments, as shown in FIG. 6, an embodiment of this application further provides an eye tracking method, applied to the eye tracking apparatus 100 according to any one of the foregoing embodiments described in FIG. 1 to FIG. 5. FIG. 6 is a schematic flowchart of an eye tracking method according to an embodiment of this application.

The method includes the following steps.

Step 202. Emit to human eyes a first fill light ray with a first predetermined central wavelength or a second fill light ray with a second predetermined central wavelength based on ambient light intensity of the human eyes, where solar spectral irradiance corresponding to the first predetermined central wavelength and the second predetermined central wavelength is less than a predetermined threshold, and a band range of the first fill light ray is different from a band range of the second fill light ray.

Step 204. Acquire a pupil image formed when the first fill light ray or the second fill light ray irradiates the human eyes.

Step 206. Determine movement of the human eyes based on the pupil image.

In some embodiments, the emitting to human eyes a first fill light ray with a first predetermined central wavelength or a second fill light ray with a second predetermined central wavelength based on ambient light intensity of the human eyes includes:
emitting the first fill light ray with the first predetermined central wavelength to the human eyes in a case that the ambient light intensity is not greater than a predetermined light intensity threshold; and
emitting the second fill light ray with the second predetermined central wavelength to the human eyes in a case that the ambient light intensity is greater than the predetermined light intensity threshold, where the band range of the second fill light ray is greater than the band range of the first fill light ray.

In some embodiments, the first predetermined central wavelength is between 1119 nm and 1121 nm, and the second predetermined central wavelength is between 1370 nm and 1390 nm.

In some embodiments, the first predetermined central wavelength is between 1370 nm and 1390 nm, and the second predetermined central wavelength is between 1370 nm and 1390 nm.

The band range of the fill light ray with the first predetermined central wavelength is determined based on the first predetermined central wavelength and a predetermined wavelength bandwidth, and the band range of the fill light ray with the second predetermined central wavelength is determined based on the second predetermined central wavelength and the predetermined wavelength bandwidth, where the predetermined wavelength bandwidth is between 20 nm and 50 nm.

In this embodiment of this application, a first fill light ray with a first predetermined central wavelength or a second fill light ray with a second predetermined central wavelength is emitted to human eyes based on ambient light intensity of the human eyes, solar spectral irradiance corresponding to the first predetermined central wavelength and the second predetermined central wavelength is less than a predetermined threshold, and a band range of the first fill light ray is different from a band range of the second fill light ray. In addition, movement of human eyes is tracked, a pupil image formed when the fill light ray irradiates the human eyes is acquired, and the movement of human eyes is determined based on the pupil image. Fill light rays whose central wavelength corresponds to a solar spectral irradiance below a predetermined threshold are emitted. This can minimize or even eliminate the interference of sunlight on the fill light rays emitted by the fill light source to human eyes even under strong outdoor light. As a result, a pupil image with a high signal-to-noise ratio can be obtained through that fill light ray, thereby improving the pupil image quality. In addition, this further avoids the increase of power consumption and harm to human eyes caused by increasing the power of the fill light lamp for improved pupil image quality. Furthermore, human eyes are irradiated by fill light rays of various wavelengths based on ambient light intensity of human eyes, and different fill light sources are used according to different ambient light intensities. This reduces the power consumption of the eye tracking apparatus and improves the operational efficiency thereof.

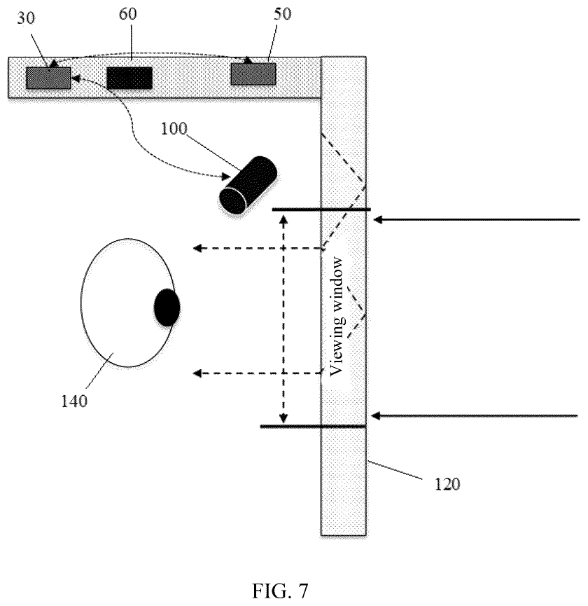

In some embodiments, as shown in FIG. 7, an embodiment of this application further provides smart glasses, including a light intensity sensor 50, the processor 30, and the eye tracking apparatus 100 according to any one of the foregoing embodiments illustrated in FIG. 1 to FIG. 5. The eye tracking apparatus 100 is arranged at positions on the smart glasses corresponding to a human eye 140. The light intensity sensor 50 is connected to the processor 30, and the light intensity sensor 50 is configured to detect and transmit ambient light intensity of the human eye 140 to the processor 30. The processor 30 is configured to drive the fill light source 10 to emit the first fill light ray or the second fill light ray to the human eye 140 based on a result of comparison between the ambient light intensity and the predetermined light intensity threshold.

The eye tracking apparatus 100 is arranged on a side of the smart glasses and is inclined at a certain angle relative to a human eye 140, so that the light ray emitted by the fill light source can reach the human eye 140.

The smart glasses further include a display source 60 for providing a virtual picture. Through a viewing window, the human eye 140 can see both the virtual picture from the display source and a real-world view of the external environment. Legs of the smart glasses contain at least a processor 30, the display source 60, and a light intensity sensor 50.

The light intensity sensor 50 is a near-infrared sensor, which is configured to measure the intensity of ambient light by detecting the infrared component of the ambient light, and the light intensity sensor 50 may be an 850 nm or 940 nm sensor. The 940 nm near-infrared sensor is used as an example. In indoor environments, the spectral component of ambient light at the 940 nm wavelength is small, resulting in a low output value of the near-infrared sensor. Under outdoor light having high spectral component at 940 nm wavelength, the near-infrared sensor reaches the maximum saturated output value A.

The predetermined light intensity threshold is used to determine whether to change the fill light source to emit to the human eyes the fill light ray with a different central wavelength. For example, conditions for changing between the fill light ray with the first predetermined central wavelength and the fill light ray with the second predetermined central wavelength are as follows: when the output value of the light intensity sensor 50 is less than or equal to the predetermined light intensity threshold, the first fill light source operates to emit the fill light ray with the first predetermined central wavelength for eye tracking; when the output value of the light intensity sensor 50 is greater than the predetermined light intensity threshold, the second fill light source operates to emit the fill light ray with the second predetermined central wavelength for eye tracking.

For example, the first predetermined central wavelength is 1120 nm and the second predetermined central wavelength is 1380 nm. When the output value of the light intensity sensor 50 is greater than 0.5 A, the processor 30 transmits a signal to the eye tracking apparatus 100, and only the fill light source corresponding to the central wavelength of 1380 nm is switched on. When the output value of the light intensity sensor 50 is less than or equal to 0.5 A, the processor 30 transmits a signal to the eye tracking apparatus 100, and only the fill light source corresponding to the central wavelength of 1200 nm is switched on.

In this embodiment of this application, the light intensity sensor included in the smart glasses is configured to detect the ambient light intensity of human eyes and transmit it to the processor. The processor included in the smart glasses is configured to drive the fill light source to emit to human eyes a fill light ray with a first predetermined central wavelength or a fill light ray with a second predetermined central wavelength, based on a result of comparison between the ambient light intensity and the predetermined light intensity threshold. In this way, different fill light sources can be used according to different ambient light intensities, reducing the power consumption of the eye tracking apparatus and improving the operational efficiency of the eye tracking apparatus.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scopes of the method and apparatus in the implementations of this application are not limited to performing functions in the sequence shown or discussed, and may further include performing functions at substantially the same time or in a reverse sequence according to the involved functions. For example, the described method may be performed in a sequence different from the described sequence, and steps may be added, omitted, or combined. In addition, features described with reference to some examples may be combined in other examples.

The foregoing describes the embodiments of this application with reference to the accompanying drawings. However, this application is not limited to the foregoing specific embodiments. The foregoing specific embodiments are merely illustrative rather than restrictive. As instructed by this application, a person of ordinary skill in the art may develop many other manners without departing from principles of this application and the protection scope of the claims, and all such manners fall within the protection scope of this application.

What is claimed is:

1. An eye tracking apparatus, comprising:
a fill light source, configured to emit, to human eyes, a first fill light ray with a first predetermined central wavelength or a second fill light ray with a second predetermined central wavelength based on ambient light intensity of the human eyes, wherein solar spectral irradiance corresponding to the first predetermined central wavelength and the second predetermined central wavelength is less than a predetermined threshold, and a band range of the first fill light ray is different from a band range of the second fill light ray;
a camera, configured to acquire a pupil image formed when the first fill light ray or the second fill light ray irradiates the human eyes; and
a processor, configured to determine movement of the human eyes based on the pupil image, wherein the camera tracks the movement of the human eyes.

2. The apparatus according to claim 1, wherein the fill light source comprises a first fill light source and a second fill light source, wherein
the first fill light source is configured to emit the first fill light ray to the human eyes when the ambient light intensity is not greater than a predetermined light intensity threshold; and
the second fill light source is configured to emit the second fill light ray to the human eyes when the ambient light intensity is greater than the predetermined light intensity threshold,
wherein the band range of the second fill light ray is greater than the band range of the first fill light ray.

3. The apparatus according to claim 2, wherein the camera comprises a first camera and a second camera, wherein
the first camera is configured to acquire the pupil image formed when the first fill light ray irradiates the human eyes, and the second camera is configured to acquire the pupil image formed when the second fill light ray irradiates the human eyes.

4. The apparatus according to claim 1, wherein the fill light source comprises a vertical-cavity surface-emitting laser light source.

5. The apparatus according to claim 1, wherein the camera comprises a receiver device and an image sensor that are stacked, wherein
the receiver device is configured to receive a fourth light ray, wherein the fourth light ray is a light ray with the same band as the emitted first fill light ray or second fill light ray among a third light ray reflected by the human eyes when the first fill light ray or the second fill light ray irradiates the human eyes; and
the image sensor is configured to convert an optical signal of the fourth light ray into an electrical signal.

6. The apparatus according to claim 5, wherein the receiver device comprises a receiving lens and an optical filter that are stacked, wherein
the receiving lens is a plastic aspheric structure and is configured to converge the third light ray; and
the optical filter is configured to allow the fourth light ray in the converged third light ray to pass through.

7. The apparatus according to claim 5, wherein
the receiver device is a superlens, and the superlens comprises a glass substrate, optical filter layers stacked on a first surface of the glass substrate close to the human eyes, and microstructures stacked on a second surface of the glass substrate away from the human eyes; wherein
the optical filter layer is configured to allow the fourth light ray in the third light ray to pass through; and
the microstructure is configured to converge the fourth light ray.

8. The apparatus according to claim 5, wherein the image sensor comprises a colloidal quantum dot sensor.

9. The apparatus according to claim 1, wherein
the first predetermined central wavelength is between 1119 nm and 1121 nm, and the second predetermined central wavelength is between 1370 nm and 1390 nm; or
the first predetermined central wavelength is between 1370 nm and 1390 nm, and the second predetermined central wavelength is between 1370 nm and 1390 nm; wherein
the band range of the first fill light ray with the first predetermined central wavelength is determined based on the first predetermined central wavelength and a predetermined wavelength bandwidth, and the band range of the second fill light ray with the second predetermined central wavelength is determined based on the second predetermined central wavelength and the predetermined wavelength bandwidth, wherein the predetermined wavelength bandwidth is between 20 nm and 50 nm.

10. An eye tracking method, performed by an eye tracking apparatus, comprising:
emitting, to human eyes, a first fill light ray with a first predetermined central wavelength or a second fill light ray with a second predetermined central wavelength based on ambient light intensity of the human eyes, wherein solar spectral irradiance corresponding to the first predetermined central wavelength and the second predetermined central wavelength is less than a predetermined threshold, and a band range of the first fill light ray is different from a band range of the second fill light ray;
acquiring a pupil image formed when the first fill light ray or the second fill light ray irradiates the human eyes; and
determining movement of the human eyes based on the pupil image.

11. The method according to claim 10, wherein the emitting to human eyes a first fill light ray with a first predetermined central wavelength or a second fill light ray with a second predetermined central wavelength based on ambient light intensity of the human eyes comprises:
emitting the first fill light ray with the first predetermined central wavelength to the human eyes when the ambient light intensity is not greater than a predetermined light intensity threshold; and
emitting the second fill light ray with the second predetermined central wavelength to the human eyes when the ambient light intensity is greater than the predetermined light intensity threshold,
wherein the band range of the second fill light ray is greater than the band range of the first fill light ray.

12. The method according to claim 10, wherein
the first predetermined central wavelength is between 1119 nm and 1121 nm, and the second predetermined central wavelength is between 1370 nm and 1390 nm; or
the first predetermined central wavelength is between 1370 nm and 1390 nm, and the second predetermined central wavelength is between 1370 nm and 1390 nm; wherein
the band range of the first fill light ray with the first predetermined central wavelength is determined based on the first predetermined central wavelength and a predetermined wavelength bandwidth, and the band range of the second fill light ray with the second predetermined central wavelength is determined based on the second predetermined central wavelength and the predetermined wavelength bandwidth,
wherein the predetermined wavelength bandwidth is between 20 nm and 50 nm.

13. Smart glasses, comprising:
an eye tracking apparatus arranged at positions on the smart glasses corresponding to human eyes, wherein the eye tracking apparatus comprises:
a fill light source, configured to emit, to the human eyes, a first fill light ray with a first predetermined central wavelength or a second fill light ray with a second predetermined central wavelength based on ambient light intensity of the human eyes, wherein solar spectral irradiance corresponding to the first predetermined central wavelength and the second predetermined central wavelength is less than a predetermined threshold, and a band range of the first fill light ray is different from a band range of the second fill light ray;
a camera, configured to acquire a pupil image formed when the first fill light ray or the second fill light ray irradiates the human eyes; and
a processor, configured to determine movement of the human eyes based on the pupil image, wherein the camera tracks the movement of the human eyes; and
a light intensity sensor connected to the processor, and configured to detect and transmit the ambient light intensity of the human eyes to the processor,
wherein the processor is configured to drive the fill light source to emit the first fill light ray or the second fill light ray to the human eyes, based on a result of comparison between the ambient light intensity and a predetermined light intensity threshold.

14. The smart glasses according to claim 13, wherein the fill light source comprises a first fill light source and a second fill light source, wherein
the first fill light source is configured to emit the first fill light ray to the human eyes when the ambient light intensity is not greater than the predetermined light intensity threshold; and
the second fill light source is configured to emit the second fill light ray to the human eyes when the ambient light intensity is greater than the predetermined light intensity threshold,
wherein the band range of the second fill light ray is greater than the band range of the first fill light ray.

15. The smart glasses according to claim 14, wherein the camera comprises a first camera and a second camera, wherein
the first camera is configured to acquire the pupil image formed when the first fill light ray irradiates the human eyes, and the second camera is configured to acquire the pupil image formed when the second fill light ray irradiates the human eyes.

16. The smart glasses according to claim 13, wherein the camera comprises a receiver device and an image sensor that are stacked, wherein
the receiver device is configured to receive a fourth light ray, wherein the fourth light ray is a light ray with the same band as the emitted first fill light ray or second fill light ray among a third light ray reflected by the human eyes when the first fill light ray or the second fill light ray irradiates the human eyes; and
the image sensor is configured to convert an optical signal of the fourth light ray into an electrical signal.

17. The smart glasses according to claim 16, wherein the receiver device comprises a receiving lens and an optical filter that are stacked, wherein
the receiving lens is a plastic aspheric structure and is configured to converge the third light ray; and
the optical filter is configured to allow the fourth light ray in the converged third light ray to pass through.

18. The smart glasses according to claim 16, wherein
the receiver device is a superlens, and the superlens comprises a glass substrate, optical filter layers stacked on a first surface of the glass substrate close to the human eyes, and microstructures stacked on a second surface of the glass substrate away from the human eyes; wherein
the optical filter layer is configured to allow the fourth light ray in the third light ray to pass through; and
the microstructure is configured to converge the fourth light ray.

19. The smart glasses according to claim 16, wherein the image sensor comprises a colloidal quantum dot sensor.

20. The smart glasses according to claim 13, wherein
the first predetermined central wavelength is between 1119 nm and 1121 nm, and the second predetermined central wavelength is between 1370 nm and 1390 nm; or
the first predetermined central wavelength is between 1370 nm and 1390 nm, and the second predetermined central wavelength is between 1370 nm and 1390 nm; wherein
the band range of the first fill light ray with the first predetermined central wavelength is determined based on the first predetermined central wavelength and a predetermined wavelength bandwidth, and the band range of the second fill light ray with the second predetermined central wavelength is determined based on the second predetermined central wavelength and the predetermined wavelength bandwidth, wherein the predetermined wavelength bandwidth is between 20 nm and 50 nm.
